(19) United States
(12) Patent Application Publication
(10) Pub. No.: US 2006/0080076 A1
(43) Pub. Date: Apr. 13, 2006

(54) System-level power estimation using heteregeneous power models

(75) Inventors: Kanishka Lahiri, Princeton, NJ (US); Nikhil Bansal, Princeton, NJ (US); Anand Raghunathan, Plainsboro, NJ (US); Srimat T. Chakradhar, Manalapan, NJ (US)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 11/200,393

(22) Filed: Aug. 9, 2005

Related U.S. Application Data
(60) Provisional application No. 60/618,046, filed on Oct. 12, 2004.

(51) Int. Cl. G06G 7/54; G06F 17/50

(52) U.S. Cl. 703/18; 716/4

(57) ABSTRACT

A power estimation framework based on a network of power monitors that observe component- and system-level execution and power statistics at run time. Based on those statistics, the power monitors (i) select between multiple alternative power models for each component and/or (ii) configure the component power models to best negotiate the trade-off between efficiency and accuracy. This approach effectuates a co-coordinated, adaptive, spatio-temporal allocation of computational effort for power estimation. This approach yields large reductions in power estimation overhead while minimally impacting power estimation accuracy.

### CROSS-REFERENCE TO RELATED APPLICATION

This application claims the priority of U.S. provisional application 60/618,046 filed 10/12/2004, which is hereby incorporated by reference as though fully set forth herein.

### BACKGROUND OF THE INVENTION

The present invention relates to techniques that estimate the power consumed by a system or circuit under design. Such techniques are used to help engineers design circuits and systems that meet desired power consumption goals.

In this specification and in the claims hereof, the term “power” is often used as a shorthand for “power consumption” or “power consumed,” as is conventional in the art. Thus references to, for example, the power of the system or of a component should be understood as meaning the power consumed by the system or component.

Power has emerged as a primary design metric for a wide range of electronic systems, ranging from battery-powered appliances to high-performance computing systems. With rising system complexity, it is becoming increasingly critical to address power early in the design cycle, particularly at the system design level when significant opportunities exist for optimizing the system architecture and application for improved power efficiency.

Extensive work has been performed in power estimation at the transistor, gate and register-transfer levels. While these techniques are invaluable at later stages of the design cycle, they are usually too inefficient for use in system-level design. As a result, a significant body of research has focused on developing power models for individual system components and thus on system-level power estimation. Most of this research has focused on power modeling techniques for individual system components, such as processors, memories, on-chip buses, peripherals and user-defined logic. These power models can be integrated into system-level simulation frameworks to provide power estimation capabilities. Due to the inherent diversity of system-on-chip (SoC) components and their design styles, system-level simulation is typically performed using a heterogeneous collection of simulation models for the different components. For example, instruction-level power modeling techniques that may be used for a processor differ significantly from analytical power models that may be used for an on-chip memory, and from transaction-level power models used for an on-chip bus.

Notwithstanding the inherent efficiency of system-level simulation when compared to lower levels of abstraction, adding power estimation computations to the functional simulation of a system results in a substantial increase in the overall computational effort—as measured by the number of computation cycles required to carry out an overall simulation of system operation—meaning that more time is required to carry out a simulation. This slowdown is due to the overhead of extracting the necessary data from the component (functional) simulation models, evaluating the power models, performing power aggregation, and reporting the results. Indeed, we have seen as much as an 8.5-fold increase in computational effort resulting from the inclusion of power estimation in a simulation run.

### SUMMARY OF THE INVENTION

In accordance with the principles of the invention, power estimation of a system under simulation is performed by estimating the power of at least one component with a level of accuracy that is selected as a function of at least one factor related to the component's power consumption.

In the disclosed embodiments, one such factor is a component's contribution to the overall system power: the higher (lower) the power contribution, the higher (lower) the accuracy. Another such factor is the dynamic variability in the component's power consumption profile: the higher (lower) the dynamic variability, the higher (lower) the accuracy. In the disclosed embodiments, both factors are taken into account jointly to determine the level of accuracy with which a component's power is estimated.

Selecting the level of accuracy is illustratively achieved by selecting from among two or more power models available for the component in question, each affording a respective level of accuracy. The computational effort (i.e., the number of computation cycles) required to estimate the power of a component is generally an increasing function of the accuracy level because achieving increased accuracy involves using commensurately more complex models. Our invention thus allocates power estimation computational effort where it has the most effect on the accuracy of the overall system power estimation. Advantageously, the sacrifice of a relatively small reduction in accuracy resulting from the use of models that are less accurate than others can very significantly reduce the computation effort required for the overall power estimation for a given level of overall power estimation accuracy. This is because, as noted above, lower-accuracy power models have lower complexity than higher-accuracy power models. Conversely, for a desired level of accuracy, the invention reduces the overall power estimation computational effort.

Parameters indicative of the selected factors, such as each component's contribution to overall power or such as the dynamic variability in its power consumption profile, could be estimated a priori, and power models offering appropriate tradeoffs between accuracy and complexity could be chosen. However, in accordance with a feature of the invention, the power models for the various components can be selected dynamically during the simulation run. This feature is based on our recognition that such factors can vary greatly over time. Such an approach allows even greater reductions in complexity and thus in computational effort for a given level of overall power estimation accuracy.

In summary, then, our invention can achieve an advantageous trade-off between overall power estimation accuracy and computational effort. When implemented dynamically as just described, the invention distributes computational effort for power estimation both spatially (across different system components) and temporally (over the duration of simulation) in a manner that tends to increase the resulting estimation accuracy. Conversely, for a desired level of accuracy, the invention allows for reduced overall computational effort.

The invention is illustratively implemented using a framework that includes a set of power monitors, each associated with one of the system components. Each power monitor measures the power of its associated component, compares it to the system power at that time, and selects a power model for the component that is appropriate for its particular percentage power contribution at that time. Each power monitor also measures the power profile of its associated component over time and develops a measure of its variability that is also used for power model selection.

The invention is not limited to the use of any particular power models. It is thus useable with power models known today as well as with any new power modeling techniques for system components that may be developed in the future.

### BRIEF DESCRIPTION OF THE DRAWING

FIG. 1 shows a typical prior art power estimation framework for a system-on-a-chip under design (“the system”);

FIG. 2 shows the computational effort required to implement a set of power models for the various components of the system as well as the power consumed by those components;

FIG. 3 shows how the power of the various system components can vary over time;

FIG. 4A illustrates how the accuracy of power estimation can vary over time for two different types of power models for a cache in the system;

FIG. 4B shows a profile of cache accesses corresponding to the time frame represented in FIG. 4A;

FIG. 5 shows a monitor-based system-level power estimation framework for the system, the framework embodying the principles of the invention;

FIG. 6 is a functional representation of one of the component-level power monitors shown in FIG. 5;

FIG. 7 illustrates a methodology for power model selection implemented by the component-level power monitors;

FIG. 8 shows power profiles obtained from system-level power estimation using the present invention and using conventional system-level power estimation;

FIG. 9 is a table presenting various power model types that can be used to estimate the power of the various components of the illustrative system;

FIG. 10 is a table showing the accuracy and efficiency achieved by the invention for different system architectures; and

FIG. 11 is a table showing the accuracy and efficiency achieved by the invention for individual system components.

### DETAILED DESCRIPTION

1. Prior Art

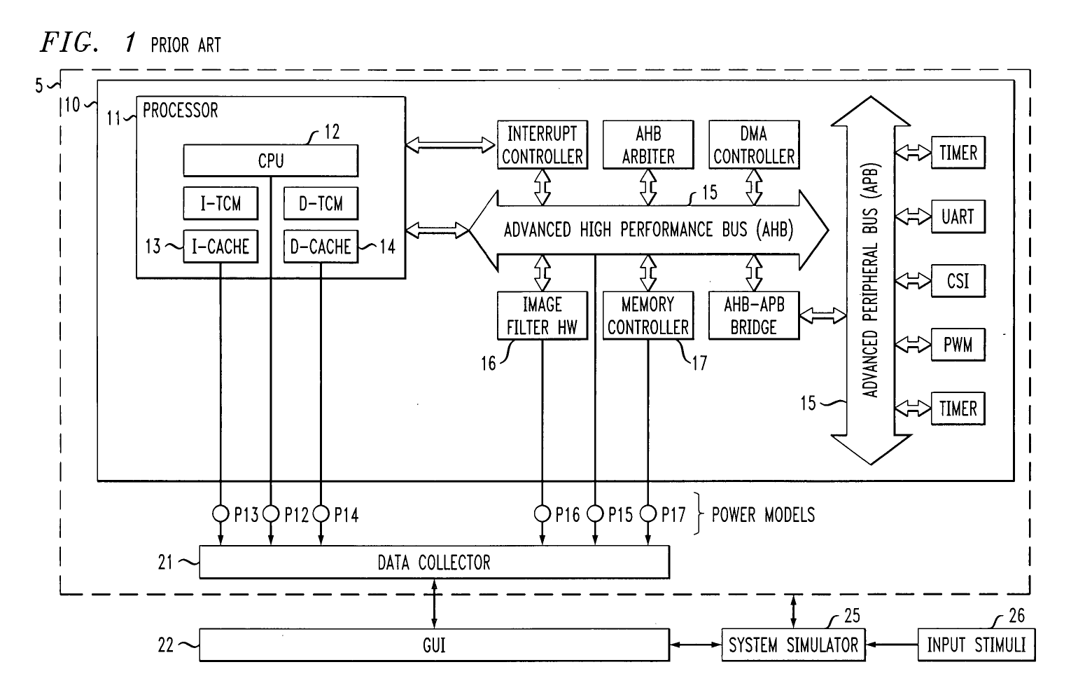

FIG. 1 depicts a typical prior art power estimation framework for estimating the power consumption of a target system-on-chip. Although the framework is shown as a block diagram of physical components, those skilled in the art will appreciate that system simulation is performed by modeling system components in software and then executing a computer program that simulates the operation of the system for a period of time based on the modeling, this being referred to here as a simulation run. During the simulation run, test inputs are postulated and system inputs and outputs, as well as other parameters, such as power consumption of various components, are computed as part of the simulation of the operation of the system.

Framework 5 of FIG. 1 includes simulatable, functional models of each component of the system-on-chip, designated as system, or platform, 10. A suite of input stimuli 26 designed by the system designer are provided to a system simulator 25 which simulates the operation of the system based on the functional models, thereby generating the system outputs that result from the input stimuli.

Framework 5 further includes power models P12 through P17. These are software modules executed by system simulator 25 that take in data indicating the input and state values of respective components of the system and provide to a data collector 21 output data indicative of the power consumed by those components.

The results of the simulation—the system outputs, the power consumption data, and other data—can then be viewed by a user via a graphical user interface, or GUI, 22.

Power models are not readily available for all types of system components. Thus carrying out a power estimation for a system being simulated is typically carried out by estimating the power for less than all of the system components. In the present example, the power models P12 through P17 respectively estimate the power of CPU 12 of the processor 11; instruction (I) and data (D) caches 13 and 14; Advanced High-Performance (AHB) on-chip bus 15 to which processor 11 is connected; and image filter hardware 16 and memory controller 17 which are also connected to bus 15. The system of platform 10 implements an image processing application that runs on the processor, retrieves image data from off-chip memory, uses image filter hardware 16 to perform basic image processing operations (smoothing, color enhancement, etc.) at the pixel level, and stores the resulting image in memory.

The other components of the system include scratch-pad memories I-TCM and D-TCM that are tightly coupled to I-cache 13 and D-cache 14, respectively and various additional components connected to bus 15 including an interrupt controller, DMA controller, an AHB arbiter and an AHB-APB bridge that bridges the AMB to an Advanced Peripheral Bus (APB) 115. Connected to the latter are standard components such as timers, a universal asynchronous receiver transmitter (UART), codec-serial interface (CSI) and a pulse-width modulator (PWM).

The level of abstraction at which each component is modeled may vary, depending on the complexity of the component, ranging from pin-accurate, register-transfer level models to more abstract models. In the experiments reported herein, we used various abstractions for system-level simulation of a type typically used by those in the art. Specifically, we used cycle-accurate, functional models for custom and standard, (e.g. memory controller) hardware, transaction-level models for the on-chip bus, and instruction-level models for embedded processors and caches. In the description herein, a reference numeral, such as reference numeral 12 for the CPU, is used to mean either the software functional model or the physical component that that model models, as will be apparent from the context.

2. Analysis of Prior Art Approach

In a particular experiment we simulated system 10 using cycle-accurate functional models for the hardware components, transaction-level models for the on-chip bus, and an instruction-level model for the processor. We initially performed pure functional simulation of the entire system as it executed the image application, and then repeated the experiment with all the component power models included. The power models we used were those generally regarded as being the state-of-the-art, meaning models that are generally regarded by those in the art as providing the best trade-off between accuracy and power model complexity.

A comparison of measured execution times revealed that the inclusion of power models caused a reduction in simulation efficiency (increase in computational effort) by a factor of more than 8.5 (here denoted “8.5×.”). This slowdown was observed in spite of using hardware power models for certain components (e.g., the image filter hardware) that operate at the cycle-accurate functional level, which requires significantly less computational effort than commercially available RT-level hardware power estimators. This illustrates the dramatic impact on overall computational effort that is caused by the incorporation of power models in the simulation.

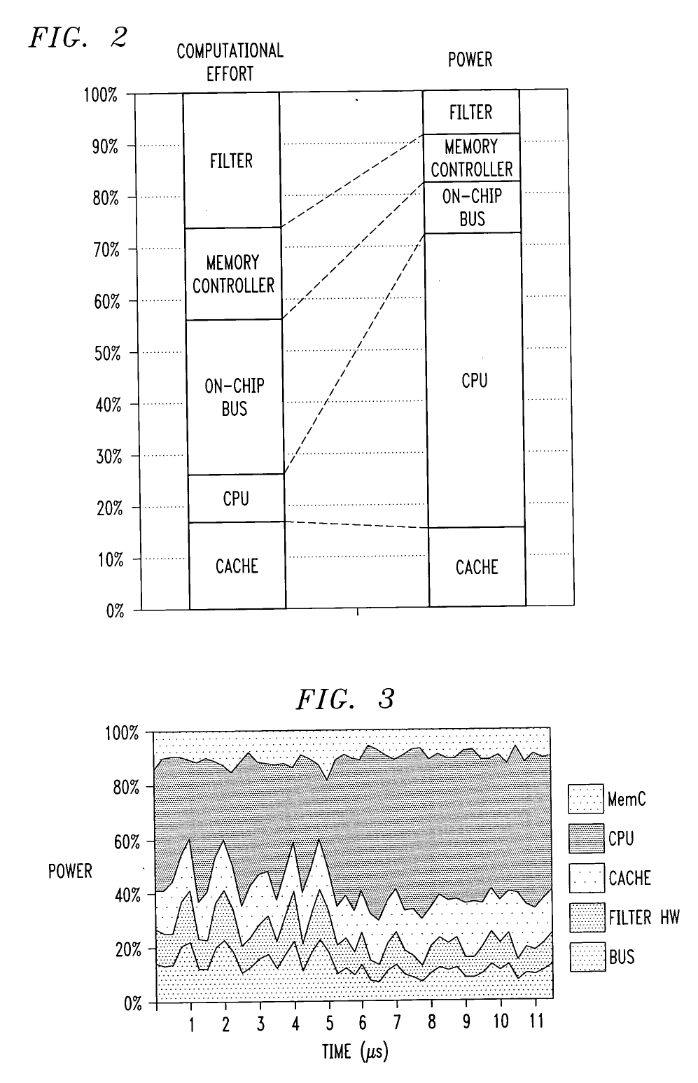

To better understand the computational effort associated with the power estimation using the aforementioned state-of-the-art power models, consider the results presented in FIG. 2. The first column presents a breakdown of the computational effort (CPU time) expended in performing power estimation for the various system components over a particular 11 μs time frame when the image application was simulated. In the data as presented, the power of the two caches is combined. The second column presents the percentage contributions of the corresponding components to overall power consumption. We observe that the allocation of computational effort poorly tracks the manner in which power is consumed by the different system components. For example, while the image filter and bus architecture together accounted for only 18% of the total power, their power models accounted for 55% of the computational effort towards power estimation. In contrast, while the processor accounted for 56% of the total power, its power model consumed only 10% of the computational effort.

These results illustrate our realization that a large discrepancy can exist between the computational effort associated with power estimation of certain components and the impact that these components have on total system power. We have thus realized that a more optimized allocation of computational effort can result in a superior trade-off between overall power estimation accuracy and computational effort.

In particular, then, power estimation of a system under simulation is performed pursuant to the principles of the invention by estimating the power of at least one component with a level of accuracy that is selected as a function of at least one factor related to the component's power consumption. In the disclosed embodiments, one such factor is a component's contribution to the overall system power: the higher (lower) the power contribution, the higher (lower) the accuracy. Thus in the example of FIG. 2, an advantageous selection of power models would favor the use of a high accuracy model for the CPU and lower accuracy models for the other components—perhaps a medium-accuracy/medium-complexity model for the cache and lower-accuracy/lower-complexity power models for the other components.

We believe that the invention can provide a desired level of accuracy with lower computational effort than in the prior art if power models are selected based on components' average power contribution. However, particular embodiments of the invention can achieve even further benefits by adapting the power estimation effort for a component based on the component's (variable) contribution to total system power over time. Thus, for at least one component, a relatively high accuracy power model is used when the component is consuming a relatively larger fraction of overall system power, and a relatively lower accuracy power model is used when the component is using a relatively smaller fraction of overall system power.

Indeed, FIG. 3, which depicts the power consumption of system 10 over the 11 μs test application time frame, shows that components may exhibit significant dynamic variation in their individual power consumption, and hence their individual power contributions over time.

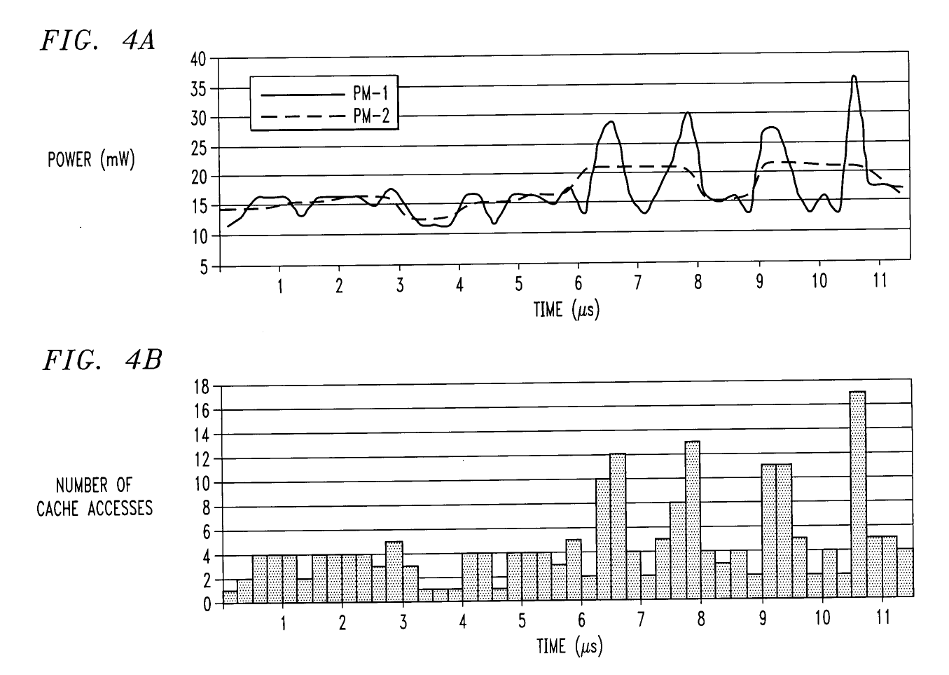

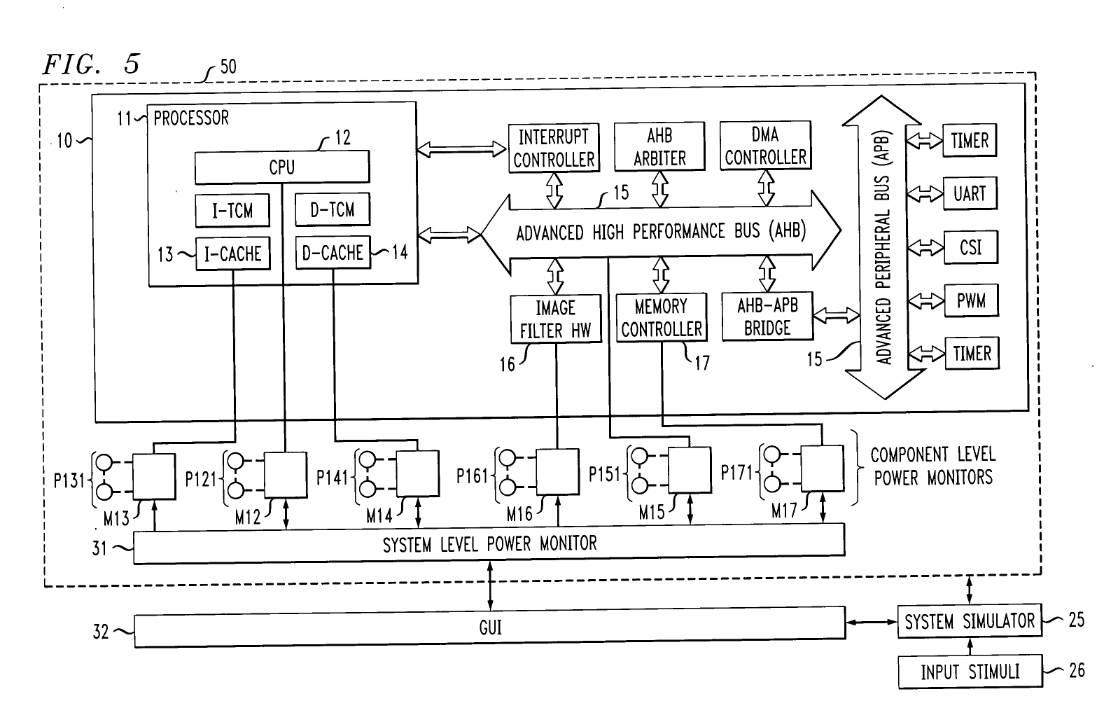

Another factor affecting the selection of power models is, illustratively, the dynamic variability in the component's power consumption profile: the higher (lower) the dynamic variability, the higher (lower) the accuracy. FIG. 4 illustrates this point relative to the power consumption of I-cache 13 over the 11 μs time frame. As shown in FIG. 4(b), the variability in the number of cache accesses over the first 6 μs test application is significantly smaller than over the last 5 μs of the time frame 5 μs of the time frame. As a result, the variability in the power consumption of the instruction cache is significantly greater during the last 5 μs.

FIG. 4(a) displays the power profile of the cache obtained using two different power models that have contrasting accuracy vs. efficiency (computational effort) characteristics. The profile marked “PM-1” is obtained using a per-access power model, which computes cache power on every clock cycle, taking activities in the address lines, bit lines, and word lines into account. The second profile (marked “PM-2”) is obtained using periodic application of a more efficient but less accurate analytical model, which estimates average power using an aggregate count of the number and types of accesses seen during a certain interval. From FIG. 4(a), we observe that within the first 6 μs of the time frame represented, the power profile generated by the analytical model tracks the profile obtained using the per-access model with an error of about 9%. Thereafter, however, the cache exhibits high variation in its power consumption, increasing the error to about 26%. Using the analytical model alone throughout the simulation would significantly compromise power profiling accuracy, whereas only using the per-access model could result in large estimation overhead.

We have thus recognized that it is advantageous to dynamically vary the choice of power model based on the dynamic variability of a component's power vs. time profile. In this particular example, use of the more accurate, per-access model would be favored during the last 5 μs of the time frame, whereas the more efficient, analytical model would be favored during the first 6 μs of the time frame. In our study, the resulting compromise in accuracy was observed to be less than 5%, while the reduction in power estimation effort was 3.4×.

3. Framework Embodying the Principles of the Invention

FIG. 5 shows a monitor-based power estimation framework 50 embodying the principles of the present invention. As in FIG. 1, the framework again includes a simulation model of the processor-based target system 10 and system simulator 25 that simulates the operation of the framework based on input stimuli 26.

Instead of having only one power model as in FIG. 1, however, framework 50 includes two or more power models for each of the components whose power is to be estimated. The power models for CPU 12, I-cache 13, D-cache 14, bus 15, image filter 16 and memory controller 17 are denoted P121, P131, P141, P151, P161 and P171, respectively. The actual number of power models associated with a given component will typically vary, depending on how many different types of models are available for the particular types of components used in the target system and depending on the extent to which it is expected that having additional choices will significantly affect the accuracy/efficiency trade-off. The various power models associated with a given component differ in terms of their accuracy and efficiency.

In some special cases, the various power models associated with a given component might be the same type of power model, such as a particular type of analytical model, but “tuned” using various different parameter values so as to achieve different levels of accuracy and complexity. For the purposes herein, such multiple tunings of a power model are regarded as being respective different power models. Such power models are not typically available for most types of components, however. Accordingly, in the present embodiment, the power models associated with a particular component are a heterogeneous set of power models, meaning that they use fundamentally different computational approaches. An example of heterogeneous models for a given component are the two cache power models mentioned above—a per-access power model and an analytical model that estimates average power using an aggregate count of the number and types of accesses seen during a certain interval.

The framework of FIG. 5 further includes a network of component-level power monitors M12 through M17, each corresponding to one of the system components whose power is being estimated. Each component-level power monitor is responsible for optimizing the selection and usage of power models for the associated component, based on conditions observed during simulation, pursuant to the principles of the present invention. Indirectly, then, the selection of particular power models to estimate the power of the associated component at various times during a simulation run is equivalent to the selection of a particular level of estimation accuracy at those various times. The power monitor thereupon generates data indicative of at least one power characteristic of the associated component. That data is illustratively a profile of the component's power over time. That profile, in turn, is made available to a system-level power monitor 31. The latter accumulates power estimates from the component-level monitors, generates system-level power statistics (e.g., a system power profile, total energy consumed), and provides feedback to component-level power monitors. The information thus generated is viewable by a user through a graphical user interface, or GUI, 32.

Advantageously, the presence of the component-level power monitors in the overall framework provides a clean separation between the functional model of each component and the set of corresponding power models, facilitating the seamless addition of new power models, while minimizing the changes to the functional models.

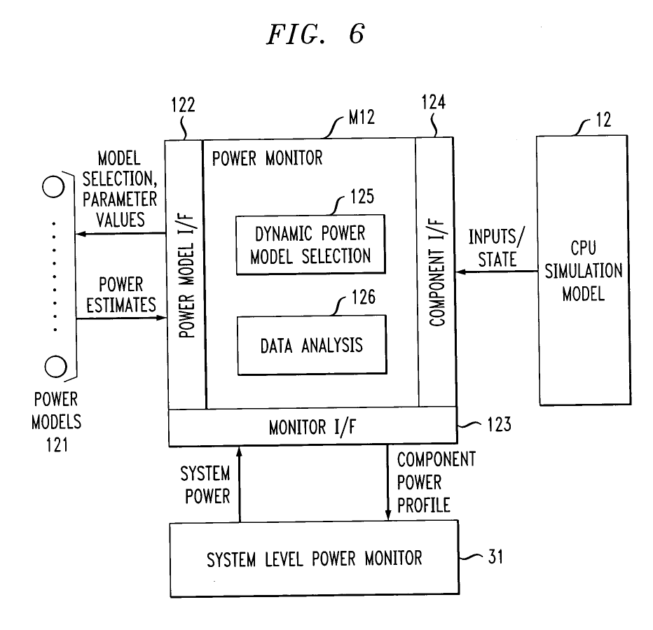

FIG. 6 provides further detail as to composition of component-level power monitor M12, and its interface with the function simulation model of CPU 12 and the associated heterogeneous power models P121. The other component-level power monitors are similarly composed and interface with their respective functional simulation models and power models in a similar way.

The above-mentioned separation between the functional model of each component and the set of corresponding power models is achieved through three interfaces. The component interface (I/F) 124 enables the extraction of data from the component simulation model, illustratively such operational parameters as the component's inputs and its state. That data is used to (i) guide the process of power model selection, and (ii) compute the values of power model parameters as described below. Power model interface (I/F) 122 is, in fact, a set of interfaces, one for each of the alternative power models 121. This interface permits the exchange of power model parameters, and power estimates, between the monitor and the power model. And system-level monitor interface (I/F) 123 enables the exchange of power consumption estimates between component-level power monitor M12 and system-level power monitor 3 1-specifically, a running estimate of total system power provided from system-level power monitor 31 and component-level power profiles provided to system-level power monitor 31.

Certain power models may require aggregate data as parameters, such as rate of cache accesses, or number of instructions executed of a certain type. To this end, a data analysis module 126 observes the necessary values at the component interface 124 and computes the required model parameters which are, in turn, passed to the power models themselves. The data analysis module may also compute additional metrics that monitor temporal variation in component activity to help guide dynamic power model selection.

Finally, component-level power monitor M12 includes dynamic power model selection 125 that selects which one of the power models 121 is to be used at any given time pursuant to the principles of the invention. The manner in which this is carried out is described below.

In summary, the overall network of component-level power monitors M12 through M17 and system-level power monitor 31 exercises dynamic, regulatory control over the overall set of power models in order to perform optimized power estimation for different parts of the system. The dynamic management of power models is performed both locally, making use of component-level power consumption characteristics, as well as globally, making use of system-level information. The power monitor network is not tied to any specific modeling abstraction and, in general, could be used to bridge potential gaps between the abstraction levels at which functionality is modeled and power is estimated.

4. Power Models

We here describe in further detail various power models that can be used in the framework of FIG. 5 for various types of system components. It is to be understood that these are only an illustrative set of power models: the framework can be easily extended to support other power models as well.

4.1. Embedded processors (e.g., CPU 12)

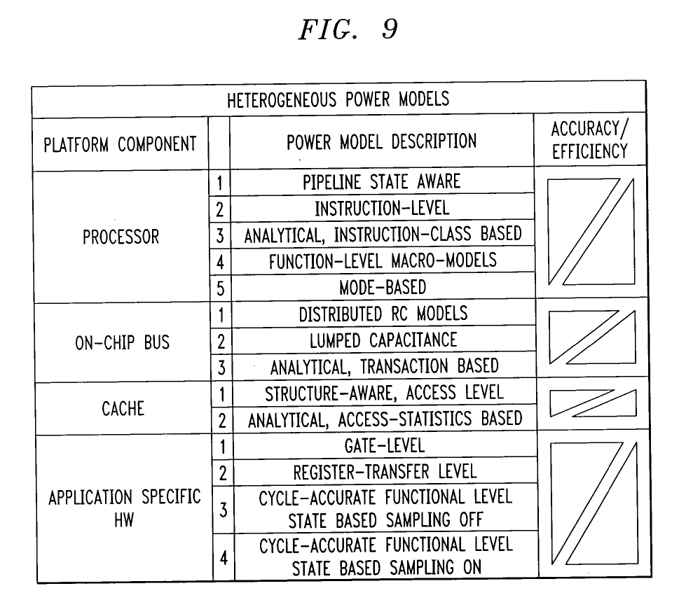

Several techniques have been developed for modeling processor power consumption at the system level. The complexity of these models varies, depending on the volume of, and frequency with which, information is extracted from a simulation model of the processor. FIG. 9 shows a table listing several alternatives, in decreasing order of computational effort, corresponding to a decreasing level of accuracy. Thus each power model in the five models listed requires more computations to carry out a particular power estimate than is required by a power model lower in the list to carry out that same power estimate.

In the first model, for every clock cycle, the complete pipeline state of the processor is captured, and the combination of instructions found in the different stages is used to estimate power consumption. See, for example, D. Brooks et al “Wattch: A Framework for Architectural-Level Power Analysis and Optimizations,” in Int. Symp. on Computer Architecture, 2000; and W. Yeet et al, “The Design and Use of SimplePower: A Cycle-Accurate Energy Estimation Tool,” in Proc. Design Automation Conf., pp. 340-345, 2000.

In the second model, for each cycle, only the instruction that is currently being executed is extracted. See, for example, A. Sinha et al “JouleTrack—A Web Based Tool for Software Energy Profiling,” in Proc. Design Automation Conf., pp. 220-225, June 2001.

In the third model, over discrete time intervals, only the number of instructions of different predefined types are counted to compute total energy or average power. See Sinha, supra.

In the fourth model, software energy macro-modeling involves monitoring code sequences of larger granularity (e.g., function calls). See, for example, T. K. Tan et al, “High-Level Software Energy Macromodeling,” in Proc. Design Automation Conf., pp. 605-610, 2001.

In the fifth and simplest power model, power estimation is based on parameters such as power modes, operating voltage, and frequency. See, for example, Sinha, supra.

4.2. On-Chip Buses (e.g., Bus 15)

Numerous models have been proposed for estimating the power consumption of global buses. Examples of such power models that we have considered in our framework are listed in FIG. 9.

In the first model, transition activity is examined on individual bus lines on every cycle and is used to estimate power using transmission line models that capture deep sub-micron effects and effects of the drivers and repeaters. See, for example, P. P. Sotiriadis et al, “A Bus Energy Model for Deep Sub-Micron Technology,” IEEE Trans. VLSI Systems, vol. 10, pp. 341-350, June 2002.

In the second model, for each cycle, aggregate transition activity is used to estimate power consumed on global buses, using a lumped capacitance to model driver, repeater, line, and parasitic capacitances.

The third model is an analytical one in which, over a certain time interval, the number and types of bus transactions are monitored, and used to estimate average transition activity, which can then be used to estimate average power.

4.3. Caches (e.g., Caches 13 and 14)

Cache power models include those that are targeted towards cycle-level simulation environments, as disclosed, for example, in Brooks, supra, as well as more efficient analytical models that are targeted towards exploring alternative cache architectures. See, for example, M. B. Kamble et al, “Analytical Models for Energy Dissipation in Low Power Caches,” in Proc. Int. Symp. Low Power Electronics & Design, pp. 143-148, August 1997; and T. D. Givargis et al, “Evaluating Power Consumption of Parameterized Cache and Bus Architectures in System-on-a-Chip Designs,” IEEE Trans. VLSI Systems, vol. 9, pp. 500-508, August 2001.

For our framework, we consider the two models listed in FIG. 9.

In the first model, on every access to the cache, the power consumed by the cache is computed based on the type of access (read/write), the result of the access (hit/miss), and transition activity on the bit and word lines. See, for example, Brooks, supra.

In the second model, over a certain time interval, statistics that capture the number and types of cache accesses are used as inputs to an analytical model that computes average cache power, using lumped capacitances for different cache components, and estimated transition activity. See, for example, Kamble and Givargis, supra.

4.4. Application Specific Logic and Platform Infrastructure Hardware (e.g., Hardware 16 and Memory Controller 17)

Power analysis of hardware, including both application-specific hardware as well as standard components such as memory controllers, timers, and other peripherals, has traditionally been performed at the gate- and register-transfer levels (RTL). Recently, advances have been made in estimating the power consumed at the cycle-accurate functional and behavioral levels. See, for example, R. Mehra et al, “Behavioral Level Power Estimation and Exploration,” in Proc. Int. Wkshp. Low Power Design, pp. 197-202, April 1994; L. Kruse et al, “Estimation of Lower and Upper Bounds on the Power Consumption From Scheduled Data Flow Graphs,” IEEE Trans. VLSI Systems, vol. 9, pp. 3-14, February 2001; and L. Zhonget al, “Power Estimation for Cycle-Accurate Functional Descriptions of Hardware,” in Proc. Int. Conf. Computer-Aided Design, 2004.

While each abstraction level in itself represents a potential trade-off between power estimation accuracy and computational effort, approaches based on logic-/RT-level power estimation are unacceptably slow. In our framework, we consider power models at the cycle-accurate, functional level. In particular, we used a technique disclosed in Zhong, supra, that embeds structural information obtained from an RTL description of a component into the corresponding cycle-accurate, functional model. This is one example of a power model that can be “tuned” as mentioned above to realize, in essence, different power models, albeit being of the same power model type.

5. Dynamic Power Model Selection

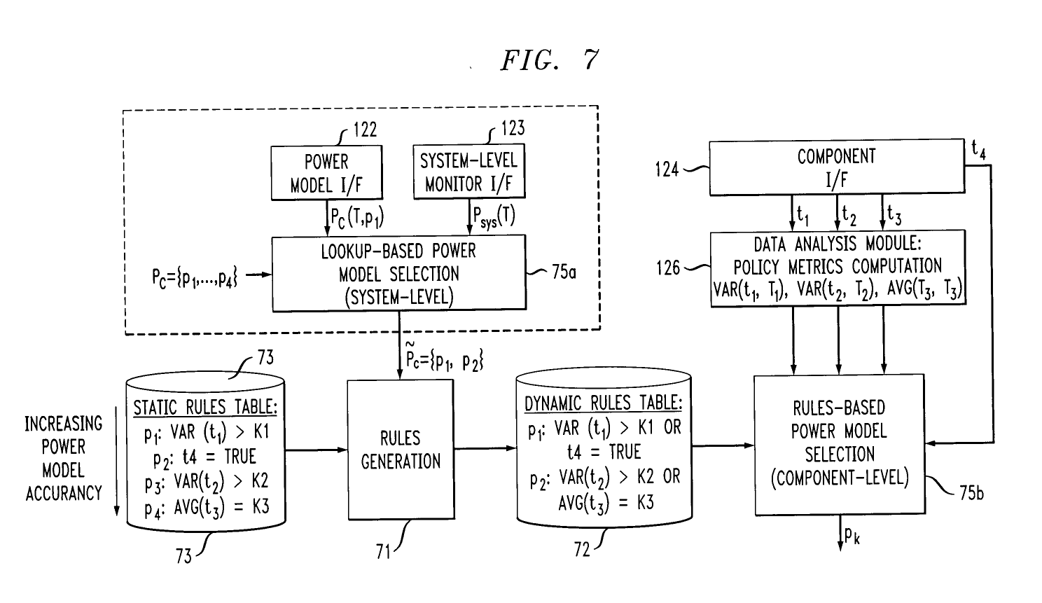

The procedure for power model selection that is executed by each component-level power monitor is presented in FIG. 7, which includes a number of the functional blocks shown in FIG. 6. (In FIG. 7, I/F means “interface.”) This procedure takes into account both of the above-described factors related to a component's power consumption used in the illustrative embodiment—the component's contribution to the overall system power and the dynamic variability in the component's power consumption profile.

The procedure receives input information from the three interfaces of the power monitor. Over the course of a simulation run, the procedure repeatedly computes an optimized power model selection for purposes of power estimation. The procedure operates in two steps. In the first step (encircled by a dashed line), system-level criteria are used to reduce the number of available choices by optimizing the spatial allocation of computational effort. Next, component-level criteria are used to choose a unique power model, which helps optimize the temporal allocation. We next discuss each of these steps in detail.

5.1. System-Level Criteria

Let P_{C}=P₁,P₂, . . . ,P_{N} be the set of power models associated with a component C, sorted in terms of decreasing accuracy and related computational effort. Let the average power consumed by the system over a time interval T be given by P_{sys}(T). A component-level monitor can observe P_{sys}(T) via the system-level monitor interface 123. Let P_{C}(T,Pᵢ) denote the power consumed by a component C over the same interval, as estimated by power model Pᵢ. The monitor computes F_{C}(T)=P_{C}(T,pᵢ)/P_{sys}(T), which is the average contribution of C to the total system power over the interval. For a component C, a set of threshold values for F_{C}(T) are pre-determined: C_{T}=C₁,C₂, . . . ,C_{M}, representing discrete values of component C's contribution to total system power. A lookup-table 75a is used to store a one-to-many mapping between C_{T} and P_{C}. For example, if Cᵢ≦F_{C}(T)≦Cⱼ,(1≦i,j≦M), the look-up table returns a set of power models \overline{P}_{C}={Pₖ:1≦k≦N}⊂P_{C}. In the lookup table, larger values of Cᵢ are mapped to more accurate (but more computationally expensive) power models, while smaller values are mapped to more abstract, efficient ones.

Note that the number of predefined thresholds M can be controlled to regulate the sensitivity of power model selection policies to system-level information. A small value of M results in higher number of power models being provided to the component-level step, making component-level criteria play a more significant role.

5.2. Component-Level Criteria

In the remainder of the methodology shown in FIG. 7, a power model Pᵢ is selected from P_{C}. The intuition behind this process is as follows. For some intervals during system execution, components may experience workloads that lend predictability to their power consumption characteristics, enabling the application of more abstract, efficient power models without significantly compromising accuracy. However, for other intervals, more accurate power models may be required.

Since the recorded history of power consumption of a component is only as accurate as the power model that is used to obtain it, using the recorded history as a basis for predicting future power consumption characteristics can be misleading. Instead, the present disclosed embodiment tracks component-specific parameters from the functional model of the component that provide an indication of component power characteristics. For example, the cache power profile shown in FIG. 4(a) is to a large extent determined by the rate of accesses, as previously noted. Hence, in the case of the cache, the variance in the rate of accesses to the cache is monitored.

Generally speaking, for each component C, a set of variables tᵢ are monitored, that we denote as triggers. The choice of triggers is component-specific and depends on the component's functionality. Examples of triggers are the execution of a specific type of instruction, access to a cache, etc. The component interface 124 receives information about the execution of triggers, and the data analysis module 126 computes specific metrics that are then used by the power model selection algorithms. FIG. 7 illustrates some of these metrics. For example, if t₁ represents the number of cache accesses in an interval, Var(t₁,T₁) represents the variance of cache access rates over a sequence of intervals of length T₁. Note that triggers may by themselves be regarded as metrics, i.e., they may not require further analysis (e.g., t₄ in FIG. 7). For example, an application-specific co-processor may have a “start” pin that is asserted each time a particular computation intensive operation is initiated. In such a case, the value of the pin is a useful metric to drive power model selection. The computed metrics are then used by the power model selector to evaluate a set of mutually exclusive conditions, which are stored in a dynamic rules table 72. For example, in FIG. 7, one of the illustrated rules in table 72 specifies that power model P₁ is to be used if the variance in the value of trigger t₁ measured over T₁ exceeds a threshold K₁, or if trigger t₄ is currently true. The mutually exclusive nature of the rules in table 72 guarantees that step 75b will select a unique power model.

We next explain the rationale for dynamic rules table 72. At run-time, the number of power models available to the component-level policy may vary, since it depends on system-level criteria. In order to address this issue, a set of rules must be developed statically for each component, assuming that all the power models associated with this component may be available at run-time. These rules are stored in a static rules table 73, in order of increasing accuracy of the associated power model. At run-time, a rules generation step 71 transforms this table, taking the actual-number of power models available into account. It constructs new rules by applying Boolean OR operators on consecutive rules in a static rules table, ensuring a one-to-one map from rules to models. The FIG. illustrates the operation of the rules generator for a component that has a maximum of 4 power models (p₁ through p₄) (table 73) but at a certain time, is restricted by the system-level policy to choose between p₁ and P₂ (table 72).

6. Experimental Results

In this section, we describe the implementation of the proposed monitor-based power estimation framework. We also present results that analyze the accuracy and efficiency of the framework for the illustrative image processing system-on-chip 10.

6.1. Experimental Methodology

In order to analyze the effectiveness of the present invention, we compared the accuracy and efficiency of the power-monitor-based framework of FIG. 5 relative to a base case. In the base case, the power model selection was fixed. Power models numbered 2, 2, 1 and 3 in FIG. 9 were used for the processor, bus, cache, and hardware respectively. Using the monitor-based framework of FIG. 5, the selected power models were varied pursuant to the principles of the invention between models 2 and 3 for the processor, models 2 and 3 for the bus, models 1 and 2 for the cache, and models 3 and 4 for other platform hardware. The base case utilizes the most accurate power model that we implemented for each component. Hence it represents a bound on the accuracy achievable by the monitor-based framework. We considered three variants of the base architecture. In Arch 1, Direct Memory Access (DMA) was disabled, but both instruction and data caches were enabled. In Arch 2, DMA was enabled but the caches were disabled. In Arch 3, DMA and caches were both enabled. The metrics used for analyzing the monitor-based framework are as follows:

Average Power Error: This refers to the error in estimating the average power consumed by the system during the entire simulation run using the monitor-based framework, relative to the base case.

Profiling Error: To quantify the accuracy of the power profile (power versus time curve) as generated by the monitor-based framework, we compute the profiling error as follows. The entire duration of the simulation was divided into intervals of equal length (for our experiments, we used an interval of 100 cycles). The estimation error in each interval was computed (relative to the base case), and then averaged (using absolute values to prevent positive and negative errors from canceling) over all the intervals.

Efficiency Gain: Improvements in power estimation efficiency were computed relative to the base case using execution time measurements.

6.2. Power Profiling Accuracy

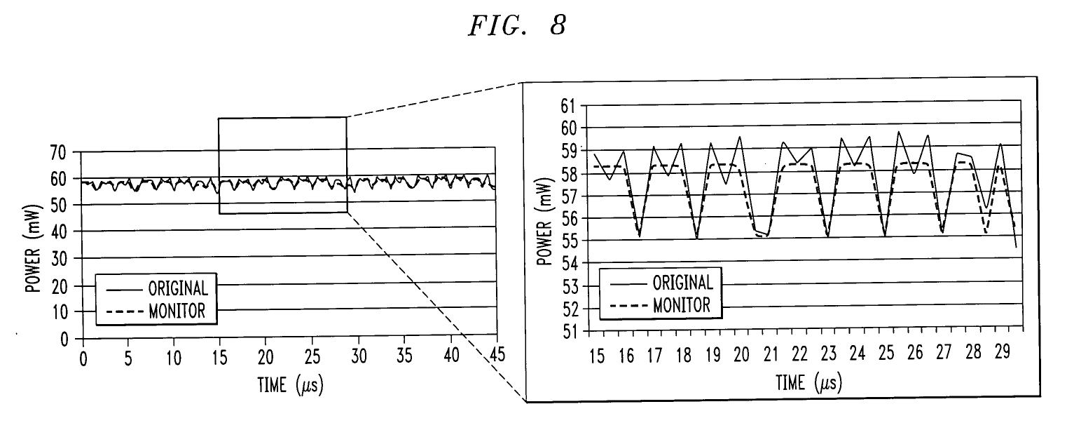

We first compare the system-level power profile as obtained by the monitor-based power estimation framework (“monitor”) with the base case (“original”). FIG. 8 illustrates the power profiles as generated by the two techniques for the architecture denoted by Arch 3 as it executes the image processing application. The FIG. shows that the power profile generated by the monitor-based framework is very close to the base case. Note that, in the callout, the y-axis has been appropriately scaled in order to make the difference between the two profiles visible. For this architecture, the profiling error was observed to be 1.08%.

6.3. Power Estimation Accuracy Versus Efficiency

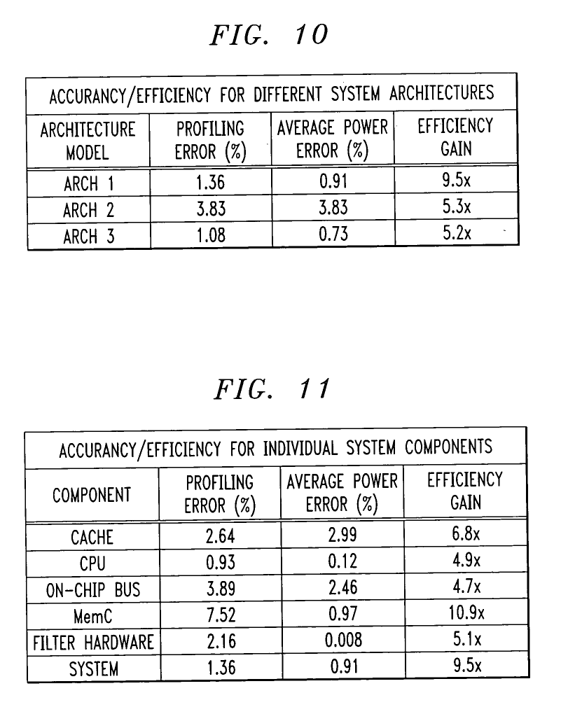

The following experiments analyze the overall power estimation accuracy and efficiency achieved by the monitor-based framework relative to the base case. For each of the three architectural variants, we compare the profiling error, average error, and efficiency gain achieved by the monitor-based framework. FIG. 10 is a table presenting the results of these experiments. The second and third columns denote the profiling errors and average power errors, respectively. The last column in this table represents the reduction in power estimation overhead. From the table, we observe significant reductions in power estimation overhead, up to almost an order of magnitude (9.5× in the first row). Upon analysis, we found that the efficiency gains were mainly due to intervals of time where more abstract power estimation models were used for different parts of the system. For significant parts of the simulation run, the monitor-based framework uses abstract models for the bus, filter hardware, and memory controller. It occasionally takes advantage of more abstract CPU and cache power models, but at most times uses more accurate models for the CPU (since it consumes a large fraction of system power), and for the cache (since it exhibits large dynamic variation in its power consumption). We observe from the table that the impact on the overall accuracy is negligible across all the architectures.

FIG. 11 shows a table analyzing the estimation results for Arch 1 in further detail. The results in the table illustrate the contribution of different components to the overall power estimation speedup and accuracy loss. For some components, the accuracy loss is relatively high (e.g., the memory controller exhibits a profiling error of 7.5%). However, since the contribution of these components to total system power is small, the system-level profiling error is insignificant—in this case, 1.36%. However, the benefits in terms of speedup are substantial. From the table, we observe a reduction of almost 11× in terms of power estimation overhead for the memory controller. This goes a long way in achieving the overall speedup of almost an order of magnitude. The above results demonstrate that the monitor-based framework successfully uses abstract power models for efficiency gains, whenever it is possible to do so without significantly compromising system-level power estimation accuracy.

The foregoing merely illustrates the principles of the invention. For example, the invention is described herein in the context of system-level power estimation, but is not limited to any particular level of design abstraction.

For example, similar concepts may be applied to RTL power estimation, where model complexity is adapted, based on contribution of the corresponding RTL instances to the total power of a circuit. The concepts underlying the invention are also not limited to the set of power models described. Nor are they limited to the particular power-related factors (power contribution and variability) used herein to determine the level of estimation accuracy to be used at a given time. Moreover, numerous variations of the procedure for power model selection may be devised, differing in terms of the relative importance given to system and component-level information, the exact component-level metrics used, etc.

It will thus be appreciated that those skilled in the art will be able to devise numerous alternative methods and arrangements that, although not explicitly shown or described herein, embody the principles of the invention and thus are within its spirit and scope.

1. A method for estimating at least one power characteristic of a system, the method comprising
estimating at least one power characteristic of at least one component of the system with a level of accuracy that is selected as a function of at least one of: a) an estimate of that component's contribution to overall system power, and b) the dynamic variability of that component's power consumption profile.

2. The method of claim 1 wherein said method is performed as part of a simulation of the operation of said system.

3. The method of claim 2 further comprising generating output data indicative of said at least one power characteristic.

4. The method of claim 3 wherein said output data comprises the power of said component over time.

5. The method of claim 1 wherein said level of accuracy is selected as a function of at least b) and wherein said estimating includes estimating said component's power over time by tracking at least one component-specific parameter from a functional model of that component that is indicative of the component's power over time.

6. The method of claim 1 wherein said level of accuracy is selected over the course of a simulation run of the system as a function of at least one of: an estimate of said component's contribution to overall system power at various times during the simulation run and an estimate of the dynamic variability in said component's consumption profile.

7. The method of claim 6 wherein said estimating is carried out by at least a first power model with a first level of accuracy during at least one portion of the simulation run and is carried out by at least a second power model with a second, lower level of accuracy during at least one other portion of the simulation run.

8. The method of claim 7 wherein said first power model is such as to require more computations to carry out a particular power estimate than is required by said second power model to carry out that same power estimate.

9. A method comprising
performing a simulation of the operation of a system, and
estimating the power of each of a plurality of components of the system at one or more times during the simulation,
said estimating using one or more power models to estimate the power of respective ones of said components during the simulation,
said estimating using a selected one of at least first and second power models to estimate of the power of at least a particular one of the components during at least one portion of said simulation, and
said estimating using another one of said at least first and second power models to estimate of the power of said particular component during at least one other portion of said simulation,
said first and second power models being selected as a function of at least one of: a) an estimate of that component's contribution to overall system power during said portions, and b) the dynamic variability of that component's power consumption profile during said portions.

10. The method of claim 9 wherein
the simulation comprises the execution of a computer program that simulates the operation of the system based on functional models of said components, and
each said power model comprises software that receives data generated during the simulation by the functional model of the particular component indicative of operational parameters of the respective component during the simulation.

11. The method of claim 10 wherein said dynamic variability is determined by estimating said particular component's power over time by tracking at least one component-specific parameter from the functional model of that component that is indicative of the component's power over time.

12. The method of claim 9 wherein
said first power model estimates the power of said particular component with a first level of accuracy, and
said second power model estimates the power of said particular component with a second level of accuracy that is less than said first level of accuracy.

13. The method of claim 12 wherein
said first power model is such as to require more computations to generate an estimate of the power of said one component than would be required by said second power model to generate the same estimate.

14. The method of claim 13 wherein
the system is a processor-based system designed to be implemented in integrated circuit form,
the simulation comprises the execution of a computer program that simulates the operation of the system based on a software model of the system, and
each said power model is software that receives data generated during the simulation indicative of operational parameters of the respective component during the simulation.

15. In combination,
a model of a system having a plurality of components, and
one or more power monitors each associated with a particular one of said components and having at least first and second associated power models each executable to generate estimates of the power of said particular component with respective first and second levels of accuracy,
said each power monitor being adapted to invoke the operation of said first and second power models during respective portions of a simulation run of the system as a function of at least one of: an estimate of the power of the associated component during said respective portions and the dynamic variability of the power consumption profile of the associated component during said respective portions.

16. The invention of claim 15 further comprising means for carrying out a simulation of said system and for providing data to said each power monitor indicative of operational parameters of the associated component during the simulation.

17. The invention of claim 16 wherein
said first level of accuracy is greater than said second level of accuracy,
said first power model requires more computations to generate a particular power estimate than would be required by said second power model to generate the same power estimate,
said each power monitor is adapted to estimate the percentage of the total power of said system caused by the associated component at at least particular portions of said simulation run, and
said each power monitor is adapted to invoke the operation of said first and second power models during respective ones of said portions of the simulation, said percentage being higher during at least one of said portions than during at least one other of said portions.

18. The method of claim 16 wherein said dynamic variability is determined by estimating the associated component's power over time by tracking at least one component-specific parameter of that component that is indicative of the component's power over time.

19. The system of claim 17 further comprising a system level power monitor that is adapted to estimate said total power of said system during said simulation run.

20. The system of claim 19 wherein said each component-associated power monitor is adapted to select which of said power models to invoke using at least one system-level criterion to select a subset of said associated power models and using at least one using component-level criterion to choose a particular power model from the subset.

21. The system of claim 20 wherein said at least one system-level criterion selects said subset in such a way as to optimize the spatial allocation of computational effort and wherein said at least one component-level criterion selects said particular power model in such a way as to optimize the temporal allocation of computational effort.

22. The system of claim 21 wherein said at least one system-level criterion is percentage contribution to total system power.

23. The system of claim 21 wherein said at least one system-level criterion is power consumption dynamic variability.

24. A method for estimating at least one power characteristic of a system, the method comprising
estimating at least one power characteristic of at least one component of the system with a level of accuracy that is selected as a function of at least one factor related to the component's power consumption.

25. The method of claim 24 wherein said method is performed as part of a simulation of the operation of said system.

26. The method of claim 25 further comprising generating output data indicative of said at least one power characteristic.

27. The method of claim 26 wherein said output data comprises the power of said component over time.

28. The method of claim 27 wherein said estimating is carried out by at least a first power model with a first level of accuracy during at least one portion of the simulation run and is carried out by at least a second power model with a second, lower level of accuracy during at least one other portion of the simulation run.

29. The method of claim 28 wherein said first power model is such as to require more computations to carry out a particular power estimate than is required by said second power model to carry out that same power estimate.

30. A method comprising
performing a simulation of the operation of a system, and
estimating the power of each of a plurality of components of the system at one or more times during the simulation,
said estimating using one or more power models to estimate the power of respective ones of said components during the simulation,
said estimating using a selected one of at least first and second power models to estimate of the power of at least a particular one of the components during at least one portion of said simulation, and
said estimating using another one of said at least first and second power models to estimate of the power of said particular component during at least one other portion of said simulation,
said first and second power models being selected as a function of at least one factor related to the component's power consumption during said portions.

31. The method of claim 30 wherein
the simulation comprises the execution of a computer program that simulates the operation of the system based on functional models of said components, and
each said power model comprises software that receives data generated during the simulation by the functional model of the particular component indicative of operational parameters of the respective component during the simulation.

32. The method of claim 30 wherein
said first power model estimates the power of said particular component with a first level of accuracy, and
said second power model estimates the power of said particular component with a second level of accuracy that is less than said first level of accuracy.

33. The method of claim 32 wherein
said first power model is such as to require more computations to generate an estimate of the power of said one component than would be required by said second power model to generate the same estimate.

34. The method of claim 33 wherein
the system is a processor-based system designed to be implemented in integrated circuit form,
the simulation comprises the execution of a computer program that simulates the operation of the system based on a software model of the system, and
each said power model is software that receives data generated during the simulation indicative of operational parameters of the respective component during the simulation.

35. In combination,
a model of a system having a plurality of components, and
one or more power monitors each associated with a particular one of said components and having at least first and second associated power models each executable to generate estimates of the power of said particular component with respective first and second levels of accuracy,
said each power monitor being adapted to invoke the operation of said first and second power models during respective portions of a simulation run of the system as a function of at least one factor related to the component's power consumption during said respective portions.

36. The invention of claim 35 further comprising means for carrying out a simulation of said system and for providing data to said each power monitor indicative of operational parameters of the associated component during the simulation.

37. The system of claim 36 wherein said each component-associated power monitor is adapted to select which of said power models to invoke using at least one system-level criterion to select a subset of said associated power models and using at least one using component-level criterion to choose a particular power model from the subset.

38. The system of claim 37 wherein said at least one system-level criterion selects said subset in such a way as to optimize the spatial allocation of computational effort and wherein said at least one component-level criterion selects said particular power model in such a way as to optimize the temporal allocation of computational effort.

39. The system of claim 38 wherein said at least one system-level criterion is percentage contribution to total system power.

40. The system of claim 38 wherein said at least one system-level criterion is power consumption dynamic variability.
